(19) United States
(12) Patent Application Publication
(10) Pub. No.: US 2025/0388407 A1
(43) Pub. Date: Dec. 25, 2025

(54) WEAR-RESISTANT WIRE-MESH METAL-BELT CONVEYORS

(71) Applicant: Laitram, L.L.C., Harahan, LA (US)

(72) Inventor: David W. Bogle, Franklinton, LA (US)

(21) Appl. No.: 18/992,518

(22) PCT Filed: Jun. 16, 2023
(86) PCT No.: PCT/US2023/025595

§ 371 Date: Jan. 8, 2025

Related U.S. Application Data
(60) Provisional application No. 63/394,676, filed on Aug. 3, 2022.

(51) Int. Cl. B65G 17/08

(52) U.S. Cl. CPC B65G 17/083

(57) ABSTRACT

A belt conveyor comprising a modular conveyor belt constructed of a series of belt rows joined at hinge joints and having an intermediate article-supporting section formed by a spiral wire mesh having first regions with a first transverse pitch alternating with one or more second regions with a lesser second transverse pitch. The one or more second regions are positioned across the width of the belt to contact one or more wearstrips on the belt's carryway.

### BACKGROUND

The invention relates generally to power-driven conveyors and more particularly to wire-mesh metal-belt conveyors.

Wire-mesh metal conveyor belts are used to convey products. The belts are constructed of a series of belt rows connected end to end by hinge rods at hinge joints between adjacent rows. Tension links at opposite sides of each belt row bear the tension in the belt as it is driven. In many cases the tension links are engaged and driven by drive elements, such as sprocket teeth. A wire mesh, in the form of a spiral, loops multiple times around the hinge rods at the ends of each belt row between the tension links. Conveyed products sit on the wire mesh. The spiral has a transverse pitch between consecutive loops that provides adequate open area for airflow or drainage. Usually, the transverse pitch is constant across the belt row. The conveyor belt is supported atop wearstrips on a carryway. The regions of the wire mesh that slide on the wearstrips as the belt advances along the carryway wear more rapidly than the regions that don't contact the wearstrips. The rapid wear of those regions reduces the useful life of the wire mesh.

### SUMMARY

One version of a conveyor belt embodying features of the invention comprises a plurality of belt rows extending in width from a first outer side to a second outer side and in a conveying direction from a first end to a second end. Each belt row includes a first tension link at the first outer side and a second tension link at the second outer side. The first and second tension links each have a first rod hole at the first end and a second rod hole at the second end. A wire mesh extends around hinge rods at the first and second ends of each belt row between the first and second tension links. The wire mesh is in the form of a spiral having a first transverse pitch in spaced-apart first regions across the width of each belt row and a different second transverse pitch in one or more second regions each between two of the first regions across the width of the belt row. The first rod holes of the first and second tension links of each belt row are aligned with the second rod holes of the first and second tension links of an adjacent belt row. The hinge rods extend through the aligned first and second rod holes and the wire mesh at the first and second ends of the adjacent belt rows to join the belt rows together at hinge joints between adjacent belt rows.

One version of a conveyor embodying features of the invention comprises a carryway extending in length in a conveying direction and in width from a first side to a second side, one or more wearstrips extending along the length of the carryway between the first and second sides, and a conveyor belt supported in the carryway on the one or more wearstrips. The conveyor belt includes a series of belt rows hingedly joined end to end at hinge joints by hinge rods. A wire mesh extends around the hinge rods of each belt row in the form of a spiral having a first transverse pitch in spaced-apart first regions across the width of each belt row and a smaller second transverse pitch in one or more second regions across the width of the belt row. The one or more second regions of each belt row contact one or more of the one or more wearstrips on the carryway.

### BRIEF DESCRIPTION OF THE DRAWINGS

FIG. 1 is a top plan view of a portion of a belt conveyor embodying features of the invention.

FIG. 2 is an enlarged isometric view of a portion of the belt conveyor of FIG. 1.

FIG. 3 is an isometric view of a portion of a single belt row of the conveyor belt of FIG. 1.

### DETAILED DESCRIPTION

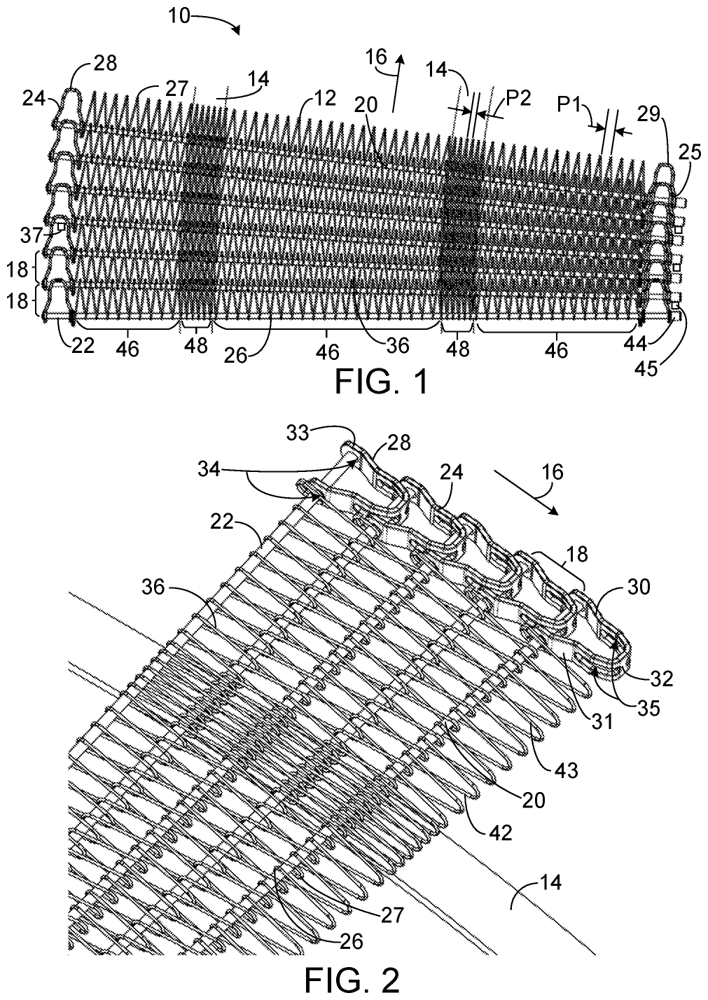

Various portions of a belt conveyor embodying features of the invention are shown in FIGS. 1-3. The conveyor 10 comprises a modular conveyor belt 12 riding on carryway wearstrips 14 in a conveying direction 16. The conveyor belt 12 is constructed of a series of belt rows 18 joined at hinge joints 20 by hinge rods 22. Each belt row 18 extends in width from a first outer side 24 to an opposite second outer side 25. Each row 18 extends in the conveying direction 16 from a first end 26 to a second end 27. Tension links 28, 29 at the first and second outer sides 24, 25 bear the belt tension as the belt 12 is driven in the conveying direction 16. On a curved belt run, the tension links 28 at the outside of a turn bear the majority, if not all, of the belt tension. On a straight run, the belt tension is shared by the tension links 28, 29 on both outer sides 24, 25.

The tension links 28, 29 in this example are shown in FIG. 2 as generally U-shaped with two legs 30, 31 diverging from a base 32. First rod holes 34 through distal ends 33 of the legs 30, 31 of the tension link 28 along the first outer side 24 of each belt row 18 are aligned with each other and with the first rod holes of the tension link 29 along the second outer side 25 of the row 18. Second rod holes 35 elongated in the conveying direction 16 near the base 32 of the first tension link 28 of each belt row 18 are aligned with each other and with the second rod holes of the corresponding second tension link 29 at the other outer side of the row. As shown in FIG. 1, sprocket teeth 37 received in the interior of the U-shaped tension links 28, 29 between the legs 30, 31 push against the hinge rods 22 to drive the belt in the conveying direction 16.

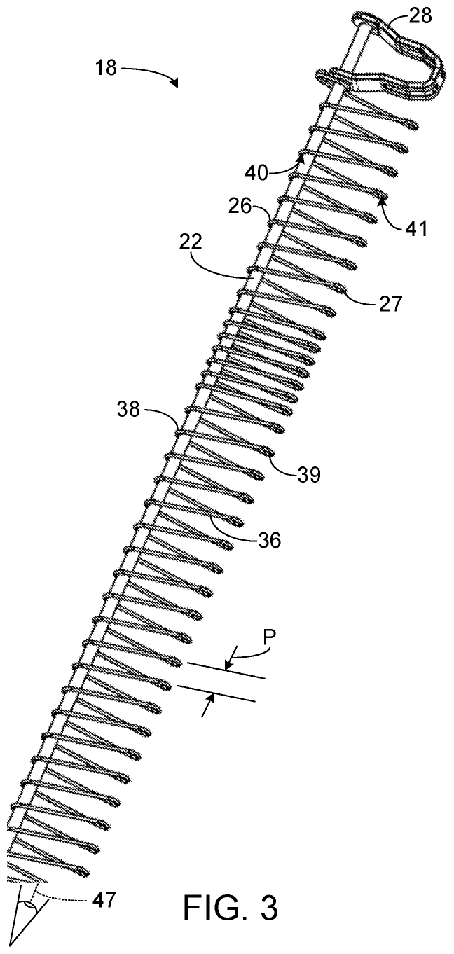

A spiral round-wire mesh 36 forms an article-supporting section of the belt 12 between the two tension links 28, 29 of each belt row 18. As shown in FIG. 3, bends 38, 39 in the spiral wire mesh 36 at the first and second ends 26, 27 of each belt row 18 define opposite ends 40, 41 of an open area of the article-supporting spiral mesh at the first and second ends. The first ends 40 of the intermediate article-supporting mesh section 36 are aligned with the first rod holes 34 in the first tension links 28. Similarly, the second ends 41 of the spiral wire mesh section 36 are aligned with the second rod holes 35 in the second tension links 29. The first end 26 of a belt row 18 overlaps the second end 27 of an adjacent belt row, and a hinge rod 22 extends through the overlapping ends to join the rows at the hinge joint 20 at which the belt can articulate. Like a coil spring, the wire mesh 36 spirals around the hinge rods 22 at the first and second ends 26, 27 of each belt row 18 between the tension links 28, 29. Bottoms 42 of the spiral mesh 36 between the curved ends 40, 41 are straight and coplanar for smooth riding along the wearstrips 14. Tops 43 of the mesh are also shown as coplanar with each other but could be curved. In an axial view along view line 47 of FIG. 3, the loops of the spiral wire mesh 36 exhibit an oval or stadium shape.

The elongated second rod holes 35 through the tension links 28, 29 allow the outer side 25 of the belt 12 to collapse at the inside of turns as shown at the right side of FIG. 1. The second rod holes could be circular in a straight-running belt because the outer sides don't have to collapse. The hinge rods 22 may also terminate in laterally extending protrusions 44 from the second tension links 29 at the second outer side 25 of the belt 12. The protrusions 44 may be engaged by positive-drive drive members 45 on the periphery of the rotating drum of a spiral conveyor, for example. Or they could be provided only at the first outer side 24 at the outside of a turn for an outside-driven belt. Protrusions could be provided at both outer sides 24, 25 of the belt 12 for a sideflexing side-driven belt capable of making left and right turns. The tension links don't have to be U-shaped. They could, for example, be flat plates with a single first rod hole and a single second rod hole.

The spiral wire mesh 36 is characterized by regions of different transverse pitches. The transverse pitch P is the distance between consecutive similar points on the spiral mesh, for example, the bends 39 at the second end 41 of the mesh as shown in FIG. 3. As best seen in FIG. 1, the wire mesh has multiple first regions 46 having a main first transverse pitch P1 spaced apart by second regions 48 having a smaller second transverse pitch P2. The metallically denser second regions 48 of the wire mesh 36 are positioned across the widths of each belt row 18 to ride directly on the wearstrips 14. The denser second regions 48 expose more surface area in contact with the wearstrips 14 to distribute the sliding pressure of the wearstrips across more loops of the spiral than if the wearstrips were in contract with the longer-pitch first regions 46. The result is an increase in the belt's wear life.

Because the wearstrips 14 are generally positioned inward of the outer sides 24, 25 of the belt 12, there would typically be more first regions 46 than the denser second regions 48. For example, if only one wearstrip 14 is used, there would be one second region 48 at the wearstrip flanked by two first regions 46. In the case of two wearstrips 14 as in FIG. 1, there are three first regions 46 aligned in the conveying direction 16 and alternating across the width of the belt 12 with two second regions 48. So, typically, there will be one more first region 46 than second regions 48. And usually the first regions 46 are adjacent to the tension links 28, 29. Because the spaces between consecutive wearstrips 14 are usually greater than the widths of the wearstrips, the first regions 46 are usually wider than the second regions 48. But that depends on the geometry of the layout. It's common in drum-driven spiral conveyors for there to be more wear on the region of the mesh that slides on the wearstrip nearest the drive drum where the drag force is greatest. So, in some cases, a denser second mesh region may be needed only at the wearstrip nearest the drive drum, where wear of the mesh is greatest.

What is claimed is:

1. A conveyor belt comprising:
a plurality of belt rows extending in width from a first outer side to a second outer side and in a conveying direction from a first end to a second end, each belt row including:
a first tension link at the first outer side and having a first rod hole at the first end and a second rod hole at the second end;
a second tension link at the second outer side and having a first rod hole at the first end and a second rod hole at the second end;
a plurality of hinge rods;
a wire mesh extending around the hinge rods at the first and second ends of each belt row between the first and second tension links in the form of a spiral having a first transverse pitch in spaced-apart first regions across the width of each belt row and a different second transverse pitch in one or more second regions each between two of the first regions across the width of the belt row;
wherein the first rod holes of the first and second tension links of each belt row are aligned with the second rod holes of the first and second tension links of an adjacent belt row and wherein the hinge rods extend through the aligned first and second rod holes and the wire mesh at the first and second ends of the adjacent belt rows to join the belt rows together at hinge joints between adjacent belt rows.

2. The conveyor belt as claimed in claim 1 wherein the first transverse pitch is greater than the second transverse pitch.

3. The conveyor belt as claimed in claim 1 wherein at least some of the first regions are adjacent the first and second tension links.

4. The conveyor belt as claimed in claim 1 wherein the first regions are wider than the second regions.

5. The conveyor belt as claimed in claim 1 wherein the number of first regions in each belt row exceeds the number of second regions by one.

6. The conveyor belt as claimed in claim 1 wherein the first regions of all the belt rows are aligned in the conveying direction and the second regions of all the belt rows are aligned in the conveying direction.

7. The conveyor belt as claimed in claim 1 wherein the spiral has a stadium shape in an axial view.

8. A conveyor comprising:
a carryway extending in length in a conveying direction and in width from a first side to a second side;
one or more wearstrips extending along the length of the carryway between the first and second sides;
a conveyor belt supported in the carryway on the one or more wearstrips, the conveyor belt including:
a series of belt rows hingedly joined end to end at hinge joints by hinge rods;
a wire mesh extending around the hinge rods of each belt row in the form of a spiral having a first transverse pitch in spaced-apart first regions across the width of each belt row and a smaller second transverse pitch in one or more second regions across the width of the belt row;
wherein the one or more second regions of each belt row contact one or more of the one or more wearstrips on the carryway.

9. The conveyor as claimed in claim 8 wherein the first regions do not contact the wearstrips.

10. The conveyor as claimed in claim 8 wherein the width of the second regions is slightly greater than the width of the wearstrips.

11. The conveyor as claimed in claim 8 wherein the conveyor belt has outer sides and tension links at the outer sides of each belt row.

12. The conveyor as claimed in claim 11 wherein each belt row has first regions adjacent the tension links.

13. The conveyor as claimed in claim 8 wherein the first regions are wider than the second regions.

14. The conveyor as claimed in claim 8 wherein the number of first regions in each belt row exceeds the number of second regions by one.

15. The conveyor as claimed in claim 8 wherein the spiral exhibits a stadium shape in an axial view.
